(19) United States
(12) Patent Application Publication
(10) Pub. No.: US 2014/0316864 A1
(43) Pub. Date: Oct. 23, 2014

(54) Systems and Methods for Reward Issuance

(71) Applicant: Tencent Technology (Shenzhen) Company Limited, Shenzhen (CN)

(72) Inventors: Ruiqin Lin, Shenzhen (CN); Zewei Xu, Shenzhen (CN)

(73) Assignee: Tencent Technology (Shenzhen) Company Limited, Shenzhen (CN)

(21) Appl. No.: 14/217,586

(22) Filed: Mar. 18, 2014

Related U.S. Application Data
(63) Continuation of application No. PCT/CN2013/086600, filed on Nov. 6, 2013.

(30) Foreign Application Priority Data
Apr. 22, 2013 (CN) 201310140922.8

(51) Int. Cl. G06Q 30/02

(52) U.S. Cl. CPC G06Q 30/0207
USPC 705/14.1

(57) ABSTRACT

Systems and methods are provided for reward issuance. An example system includes a business-layer entity, a delivery-adaptation-layer entity, and a reward-logic module in a delivery-layer entity. The business-layer entity is configured to receive a user-task-fulfillment message, generate, using one or more data processors, a reward-issuance request based on at least information associated with the user-task-fulfillment message, and output the reward-issuance request, the reward-issuance request including prize-related information. The delivery-adaptation-layer entity is configured to receive the reward-issuance request from the business-layer entity and output, using the one or more data processors, the reward-issuance request. The first reward-logic module in a delivery-layer entity is configured to receive the reward-issuance request from the delivery-adaptation-layer entity and process, using the one or more data processors, issuance of a first prize to a user based on at least the prize-related information of the reward-issuance request.

### CROSS-REFERENCES TO RELATED APPLICATIONS

This application claims priority to Chinese Patent Application No. 201310140922.8, filed Apr. 22, 2013, incorporated by reference herein for all purposes.

### BACKGROUND OF THE INVENTION

Certain embodiments of the present invention are directed to computer technology. More particularly, some embodiments of the invention provide systems and methods for data processing. Merely by way of example, some embodiments of the invention have been applied to network communities. But it would be recognized that the invention has a much broader range of applicability.

Social-networking-service (SNS) communities, such as Kaixin, QQ Space and Douban, provide core services including social networking activities to users. In a SNS community, a user can make friends based on his/her own interests, interact with friends and take part in community activities. When participating in the community activities, the user can acquire certain qualifications after fulfilling a task in order to join a prize lottery or redeem prizes. Diversified prizes, e.g., virtual articles and/or real articles, can be provided to users for better services and experiences.

But currently, in SNS community activities, service codes for reward issuance are often directly embedded in activity-logic modules, hence resulting in high system coupling and making it hard to expand the system. FIG. 1 is a simplified diagram showing a conventional system for reward issuance. As shown in FIG. 1, a conventional system 10 has a business layer overlapping with a delivery layer, which often causes a high coupling and makes it difficult to expand the entities in different layers.

Hence it is highly desirable to improve the techniques for reward issuance.

### BRIEF SUMMARY OF THE INVENTION

According to one embodiment, a system for reward issuance includes a business-layer entity, a delivery-adaptation-layer entity, and a reward-logic module in a delivery-layer entity. The business-layer entity is configured to receive a user-task-fulfillment message, generate, using one or more data processors, a reward-issuance request based on at least information associated with the user-task-fulfillment message, and output the reward-issuance request, the reward-issuance request including prize-related information. The delivery-adaptation-layer entity is configured to receive the reward-issuance request from the business-layer entity and output, using the one or more data processors, the reward-issuance request. The first reward-logic module in a delivery-layer entity is configured to receive the reward-issuance request from the delivery-adaptation-layer entity and process, using the one or more data processors, issuance of a first prize to a user based on at least the prize-related information of the reward-issuance request. The delivery-adaptation-layer entity is located between the business-layer entity and the delivery-layer entity.

According to another embodiment, a method is provided for reward issuance. For example, a reward-issuance request sent by a business-layer entity is received; the reward-issuance request is analyzed; a request identifier in the reward-issuance request; and the reward-issuance request is sent to a reward-logic module in a delivery-layer entity corresponding to the request identifier.

According to yet another embodiment, a method is provided for reward issuance. For example, a reward-issuance request sent by a business-layer entity via a delivery-adaptation-layer entity is received; the reward-issuance request is analyzed; prize-related information contained in the reward-issuance request is acquired; and issuance of a first prize to a user is processed based on at least the prize-related information.

According to yet another embodiment, a device for reward issuance includes a receiving unit, an analyzing unit, and a sending unit. The receiving unit is configured to receive a reward-issuance request sent by a business-layer entity. The analyzing unit is configured to analyze the reward-issuance request and acquire a request identifier in the reward-issuance request. The sending unit is configured to send the reward-issuance request to a reward-logic module in a delivery-layer entity corresponding to the request identifier.

In one embodiment, a device for reward issuance includes a receiving unit, an analyzing unit, and a processing unit. The receiving unit is configured to receive a reward-issuance request sent by a business-layer entity via a delivery-adaptation-layer entity. The analyzing unit is configured to analyze the reward-issuance request and acquire prize-related information contained in the reward-issuance request. The processing unit is configured to process issuance of a first prize to a user based on at least the prize-related information.

In another embodiment, a non-transitory computer readable storage medium includes programming instructions for reward issuance. The programming instructions are configured to cause one or more data processors to execute certain operations. For example, a reward-issuance request sent by a business-layer entity is received; the reward-issuance request is analyzed; a request identifier in the reward-issuance request; and the reward-issuance request is sent to a reward-logic module in a delivery-layer entity corresponding to the request identifier.

In yet another embodiment, a non-transitory computer readable storage medium includes programming instructions for reward issuance. The programming instructions are configured to cause one or more data processors to execute certain operations. For example, a reward-issuance request sent by a business-layer entity via a delivery-adaptation-layer entity is received; the reward-issuance request is analyzed; prize-related information contained in the reward-issuance request is acquired; and issuance of a first prize to a user is processed based on at least the prize-related information.

For example, the systems and methods described herein are configured to include an additional delivery-adaptation-layer entity and use a delivery-adaptation layer where the delivery-adaptation-layer entity is located to separate a business layer and a delivery layer so that the business layer and the delivery layer perform and complete their respective functions independently, so as to reduce system coupling. In another example, the systems and methods described herein are configured to add reward-logic modules to the delivery layer so as to support parallel expansion.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a conventional system for reward issuance.

FIG. 2 is a simplified diagram showing a system for reward issuance according to one embodiment of the present invention.

FIG. 3 is a simplified diagram showing the system as shown in FIG. 2 for reward issuance according to another embodiment of the present invention.

FIG. 4 is a simplified diagram showing a method for reward issuance according to one embodiment of the present invention.

FIG. 5 is a simplified diagram showing a method for reward issuance according to another embodiment of the present invention.

FIG. 6 is a simplified diagram showing a device for reward issuance according to one embodiment of the present invention.

FIG. 7 is a simplified diagram showing a device for reward issuance according to another embodiment of the present invention.

FIG. 8 is a simplified diagram showing the device as shown in FIG. 6 according to yet another embodiment of the present invention.

### DETAILED DESCRIPTION OF THE INVENTION

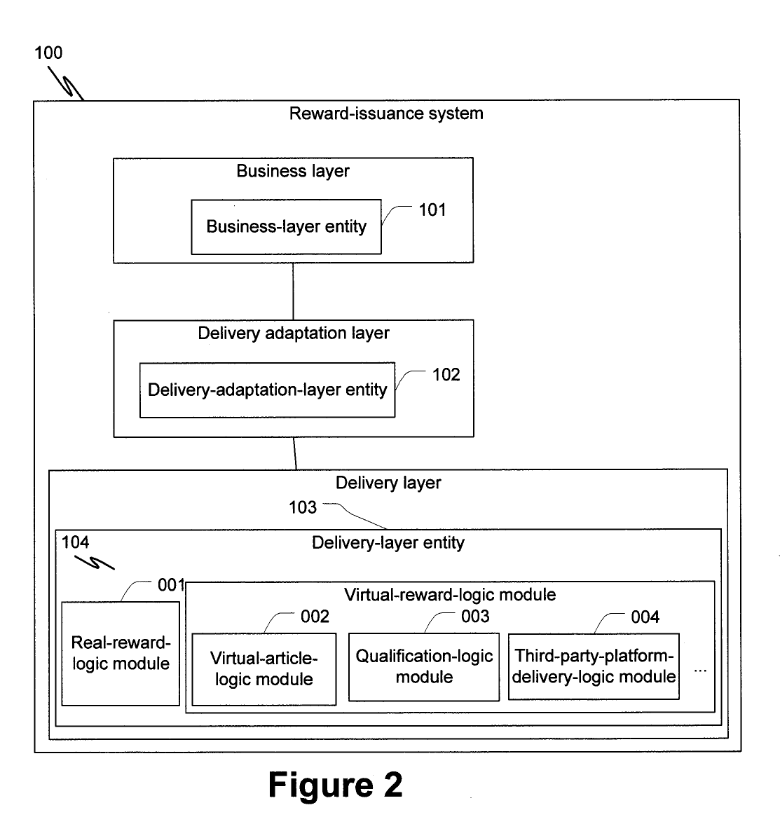

FIG. 2 is a simplified diagram showing a system for reward issuance according to one embodiment of the present invention. This diagram is merely an example, which should not unduly limit the scope of the claims. One of ordinary skill in the art would recognize many variations, alternatives, and modifications. The system 100 includes a business-layer entity 101, a delivery-adaptation-layer entity 102, a delivery-layer entity 103 and one or more reward-logic modules 104.

According to one embodiment, the business-layer entity 101 is configured to generate a reward-issuance request according to a user-task-fulfillment message received and send the reward-issuance request to the delivery-adaptation-layer entity 102. For example, the reward-issuance request includes a prize to be issued to a user. As an example, the business-layer entity 101 is located in the business layer. As shown in FIG. 2, the reward-issuance system 100 is divided into multiple layers, including a business layer, a delivery-adaptation layer and a delivery layer, in some embodiments. For example, the business layer is a core part of the reward-issuance system 100 and focuses on establishment of one or more business rules. In another example, the business rules include rewarding a user with a certain amount of prizes upon completion of one task. The business layer is realized by the business-layer entity 101, in certain embodiments.

According to another embodiment, when a user fulfills tasks on different applications, the business-layer entity 101 generates a reward-issuance request according to the type of the fulfilled task and certain activity rules related to the task or the applications. For example, if the activity rules specify that the user will be rewarded with 5 medicines for fulfillment of a task, the generated reward-issuance request includes information associated with rewarding the user with 5 medicines.

According to yet another embodiment, the delivery-adaptation-layer entity 102, located between the business-layer entity 101 and the delivery-layer entity 103, is configured to receive the reward-issuance request sent by the business-layer entity 101 and send the reward-issuance request to one or more corresponding reward-logic modules in the delivery-layer entity 103. For example, the delivery-adaptation-layer entity 102 is located in the delivery adaption layer which is located between the business layer and the delivery layer. As an example, the delivery-adaptation layer focuses on establishment of certain distribution rules for the request message sent by the business layer. For instance, the distribution rules may include sending the reward-issuance request to the corresponding reward-logic modules in the delivery-layer entity 103 according to the request identifier of the reward-issuance request from the business layer. The delivery-adaptation layer is realized by the delivery-adaptation-layer entity 102, in certain embodiments.

According to yet another embodiment, the corresponding reward-logic modules in the delivery-layer entity 103 is configured to receive the reward-issuance request sent by the delivery-adaptation-layer entity 102 and issue the prize according to the prize to be issued to the user contained in the reward-issuance request. For example, the delivery-layer entity 103 is located in the delivery layer. The delivery layer focuses on establishment of certain delivery rules, in some embodiments. For instance, the delivery rules may include issuing prizes to users according to the reward-issuance request and updating the prizes stored in the delivery layer. The delivery layer is realized by the delivery-layer entity 103, in certain embodiments. For example, the delivery layer is realized by the one or more reward-logic modules 104 in the delivery-layer entity 103.

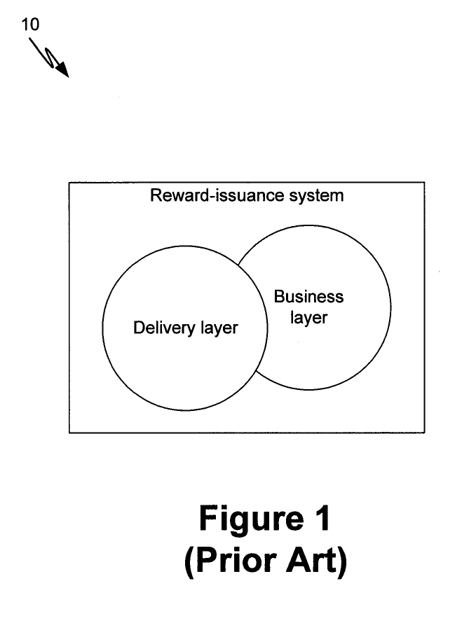

In one embodiment, the delivery-adaptation layer separates the business layer and the delivery layer. For example, the delivery-adaptation-layer entity 102 is located between the business-layer entity 101 and the delivery-layer entity 103 so that the business layer and the delivery layer perform and complete their respective functions independently. Hence, the system 100 can reduce system coupling and facilitate changes of the entities in these different layers. In contrast, a conventional system 10 (e.g., as shown in FIG. 1) has no delivery-adaptation layer and does not separates the business layer and the delivery layer (i.e., the business layer overlapping with the delivery layer), which often causes a higher coupling and makes it difficult to expand the entities in different layers.

Referring back to FIG. 2, the delivery-layer entity 103 includes the one or more reward-logic modules 104, in some embodiments. As an example, the delivery-layer entity 103 includes a real-reward-logic module and a virtual-reward-logic module. In another example, the virtual-reward-logic module is divided into a virtual-article-logic module, a qualification-logic module, a third-party-platform-delivery-logic module, etc. As shown in FIG. 2, the delivery-layer entity 103 includes a real-reward-logic module, a virtual-article-logic module, a qualification-logic module and a third-party-platform-delivery-logic module, in certain embodiments.

In some embodiments, the delivery-layer entity 103 includes a plurality of reward-logic modules so as to provide different types of rewards to users and hence improve user experience. In contrast, in the conventional system 10, the business layer and the delivery layer often overlap and certain service codes for reward issuance are often embedded in activity logic of the business layer. The system 10 hence often supports limited types of rewards, which results in poor user experience.

In another embodiment, the one or more reward-logic modules 104 include reward-issuance logic rules and prize data. For example, the reward-issuance logic rules correspond to certain prize-issuance rules. As an example, the reward-issuance logic rules include: issuing the prizes are at once, and not issuing the prizes to a user if the number of prizes is not enough for the user. For instance, the reward-issuance request involves issuing 4 prizes to a user but only 2 prizes are left. In this case, the issuance of prizes is withheld until the number of prizes becomes sufficient. In another example, the reward-issuance request further includes a request identifier which is used to determine a reward-logic module contained in the delivery-layer entity.

In yet another embodiment, upon reception of the reward-issuance request sent by the business-layer entity 101, the delivery-adaptation-layer entity 102 analyzes the reward-issuance request, acquires the request identifier and determines a reward-logic module corresponding to the request identifier in the delivery-layer entity 103 according to the request identifier. For instance, the delivery-layer entity 103 includes a real reward-logic module, a virtual-article-logic module, a qualification-logic module, a third-party-platform-delivery-logic module, etc. As an example, these logic modules are separately identified, e.g., the real-reward-logic module 001, the virtual-article-logic module 002, the qualification-logic module 003, the third-party-platform-delivery-logic module 004. These logic modules may also be identified by other means. For example, the request identifier of the reward-issuance request is 001, 002, 003, or 004.

In some embodiments, when the reward-issuance request is to reward the user with 5 medicines, the delivery-adaptation-layer entity 102 analyzes the reward-issuance request and acquires the request identifier 002. For example, the delivery-adaptation-layer entity 102 sends the reward-issuance request to the virtual-article-logic module 002 in the delivery-layer entity 103.

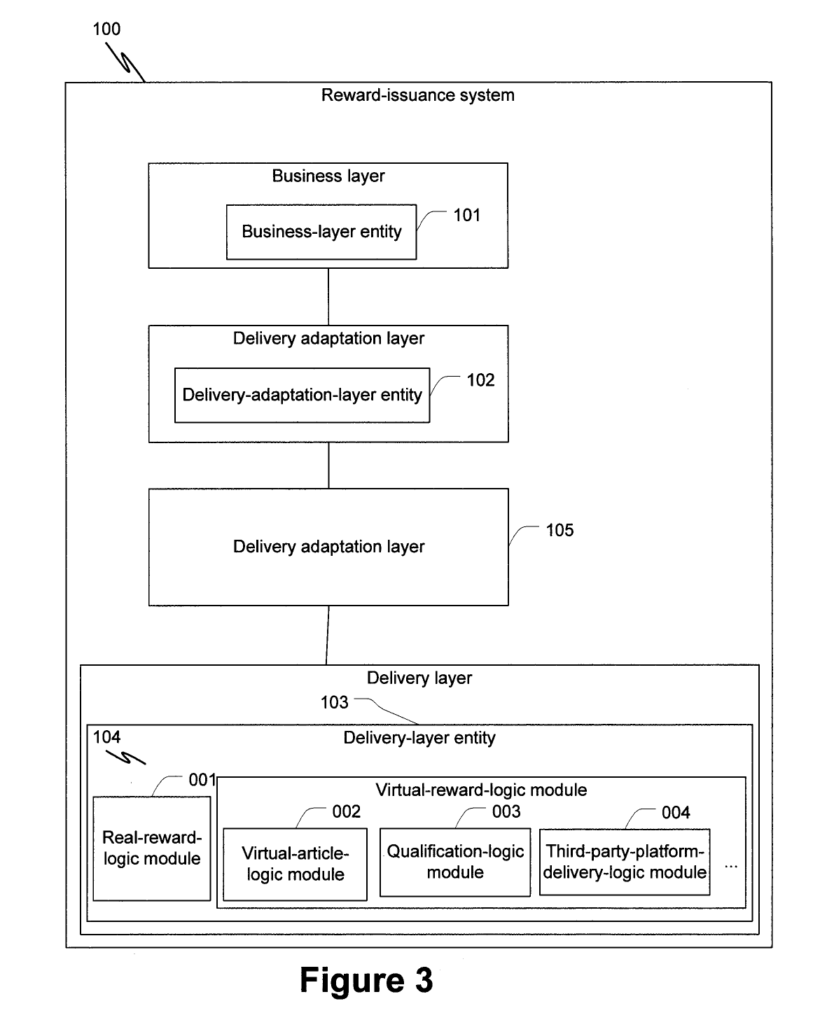

FIG. 3 is a simplified diagram showing the system 100 for reward issuance according to another embodiment of the present invention. This diagram is merely an example, which should not unduly limit the scope of the claims. One of ordinary skill in the art would recognize many variations, alternatives, and modifications. The system 100 further includes an adaptation interface 105.

According to one embodiment, the adaptation interface 105 is configured to connect the delivery-adaptation-layer entity 102 and the delivery-layer entity 103. For example, the delivery-adaptation-layer entity 102 sends to the delivery-layer entity 103 a reward-issuance request via the adaptation interface 105. As an example, the delivery-layer entity 103 receives the reward-issuance request sent by the delivery-adaptation-layer entity 102 via the adaptation interface 105 too. In another example, a new reward-logic module is added to the delivery-layer entity 103 when reward-issuance logic rules contained in the new reward-logic module conforms to the specification of the adaptation interface 105. As the business layer and the delivery layer often overlap in the conventional system 10, the system coupling is high, which leads to high cost for adding new rewards and hence low scalability. In contrast, the system 100 includes the delivery-adaptation-layer entity 102 and the adaptation interface 105, so that any addition of reward-logic module to the delivery-layer entity in the system 100 does not affect the execution of the business-layer entity 101 and the delivery-adaptation-layer entity 102 which results in a higher scalability, in some embodiments.

According to another embodiment, the reward-logic modules 104 include a real reward-logic module and a virtual-reward-logic module, and correspondingly, the reward-issuance logic rules include one or more virtual-reward-issuance logic rules and one or more real-reward-issuance logic rules. The real-reward-logic module and the virtual-reward-logic module issue prizes in different ways, in certain embodiments. For example, if a determined reward-logic module corresponds to a virtual-reward-logic module, the prize data contained in the virtual-reward-logic module is updated according to the virtual reward-issuance logic rules contained in the virtual-reward-logic module and the prize corresponding to a virtual prize is issued to the user. As an example, if 5 medicines are to be issued to the user, the data of medicine contained in the virtual-reward-logic module (for example, the virtual-article-logic module 002) is extracted to see if the number of the medicines is larger than or equal to 5. If the number of the medicines is larger than or equal to 5, the number of medicines is reduced by 5, and then the medicine data is updated and saved. The corresponding virtual prizes are issued to the user. In another example, if the determined reward-logic module corresponds to a real-reward-logic module, the prize data contained in the real-reward-logic module is updated according to the real reward-issuance logic rules contained in the real-reward-logic module, and a reminder message is generated for reminding one or more staff members to issue the corresponding real reward to the user.

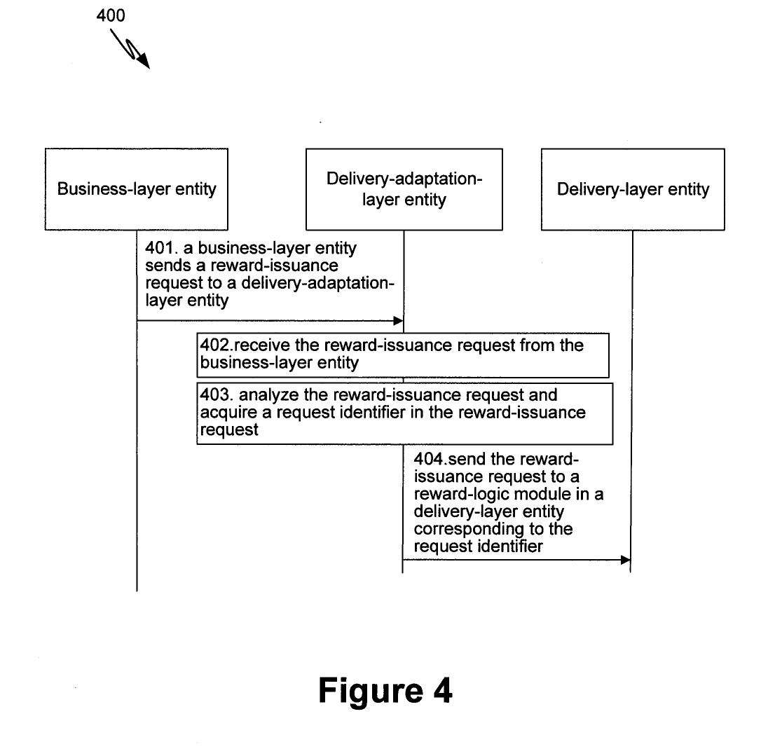

FIG. 4 is a simplified diagram showing a method for reward issuance according to one embodiment of the present invention. This diagram is merely an example, which should not unduly limit the scope of the claims. One of ordinary skill in the art would recognize many variations, alternatives, and modifications. The method 400 includes at the processes 401-404.

According to one embodiment, during the process 401, a business-layer entity sends a reward-issuance request to a delivery-adaptation-layer entity. For example, the business layer is located above the delivery-adaptation layer (e.g., as shown in FIG. 2). In another example, the business-layer entity is configured to receive a user-task-fulfillment message, generate a reward-issuance request according to the received user-task-fulfillment message, and send the reward-issuance request to the delivery-adaptation-layer entity. As an example, the reward-issuance request includes a prize to be issued to a user. For instance, when the user fulfills tasks on different applications, the business-layer entity generates a reward-issuance request according to the type of the fulfilled tasks and certain activity rules of the tasks or the applications. In another example, if the activity rules specify that the user shall be rewarded with 5 medicines for fulfillment of a task, the generated reward-issuance request includes rewarding the user with 5 medicines.

According to another embodiment, during the process 402, the delivery-adaptation-layer entity receives the reward-issuance request sent by the business-layer entity. For example, the delivery-adaptation layer where the delivery-adaptation-layer entity is located is located between the business layer and the delivery layer and separates the business layer and the delivery layer so that the business layer and the delivery layer perform and complete their respective functions independently, so as to reduce the system coupling, make it more convenient to expand the entities in various layers and increase the scalability.

According to yet another embodiment, during the process 403, the delivery-adaptation-layer entity analyzes the reward-issuance request and acquires a request identifier in the reward-issuance request. For example, the reward-issuance request further includes a request identifier which is used to determine one or more reward-logic modules contained in the delivery-layer entity. As an example, the request identifiers correspond to various reward-logic modules in the delivery-layer entity. Referring to FIG. 2, the delivery-layer entity 103 includes a real reward-logic module, a virtual-article-logic module, a qualification-logic module, a third-party-platform-delivery-logic module, etc. As an example, these logic modules are separately identified, e.g., the real-reward-logic module 001, the virtual-article-logic module 002, the qualification-logic module 003, the third-party-platform-delivery-logic module 004. These logic modules may also be identified by other means. For example, the request identifier of the reward-issuance request is 001, 002, 003, or 004.

According to yet another embodiment, during the process 404, the delivery-adaptation-layer entity sends the reward-issuance request to the corresponding one or more reward-logic modules in the delivery-layer entity according to the request identifier. For instance, if the request identifier extracted from the reward-issuance request is 002, the reward-issuance request is sent to the virtual-article-logic module 002 in the delivery-layer entity 103 (e.g., as shown in FIG. 2).

According to yet another embodiment, the reward-issuance request is sent to the corresponding one or more reward-logic modules in the delivery-layer entity via an adaptation interface according to the request identifier. For example, the adaptation interface is configured to connect the delivery-adaptation-layer entity and the delivery-layer entity. As an example, the corresponding reward-logic modules in the delivery-layer entity receive the reward-issuance request sent by the delivery-adaptation-layer entity via the adaptation interface.

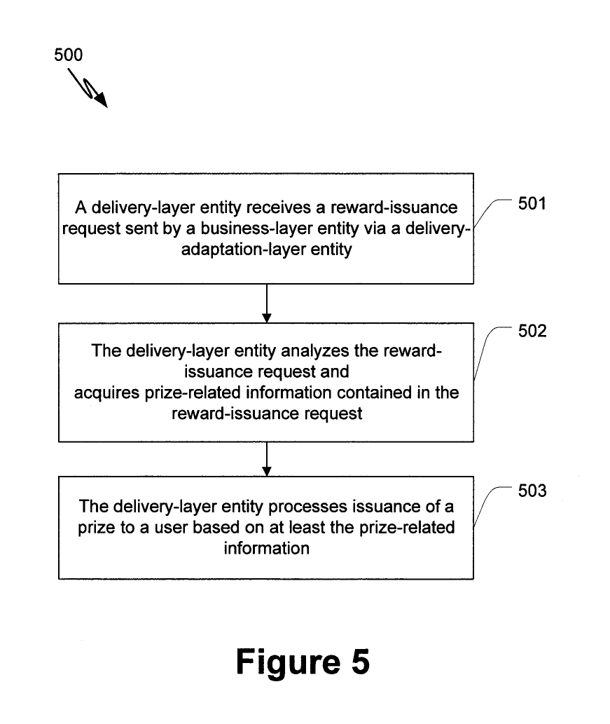

FIG. 5 is a simplified diagram showing a method for reward issuance according to another embodiment of the present invention. This diagram is merely an example, which should not unduly limit the scope of the claims. One of ordinary skill in the art would recognize many variations, alternatives, and modifications. The method 500 includes at least the processes 501-503.

According to one embodiment, during the process 501, the delivery-layer entity receives a reward-issuance request sent by a business-layer entity via a delivery-adaptation-layer entity. For example, the reward-issuance request sent by the business-layer entity is received via the delivery-adaptation-layer entity through an adaption interface. As an example, the adaptation interface is configured to connect the delivery-adaptation-layer entity and the delivery-layer entity. In another example, the business-layer entity is located in the business layer; the delivery-adaptation-layer entity is located in the delivery-adaptation layer; and the delivery-layer entity is located in the delivery layer (e.g., as shown in FIG. 2). In yet another example, the virtual-article-logic module in the delivery-layer entity receives the reward-issuance request sent by the business-layer entity via the delivery-adaptation-layer entity through the adaption interface.

According to another embodiment, during the process 502, the delivery-layer entity analyzes the reward-issuance request and acquires a prize to be issued to a user as contained in the reward-issuance request. For instance, the prize to be issued to the user contained in the reward-issuance request includes 5 medicines.

According to yet another embodiment, during the process 503, the delivery-layer entity issues the prize according to the prize to be issued to the user. For example, the delivery-layer entity issues the prize according to the prize to be issued to the user and certain reward-issuance logic rules. In another example, the reward-issuance logic rules correspond to one or more virtual-reward-issuance logic rules or one or more real-reward-issuance logic rules. As an example, the reward-logic module contained in the delivery-layer entity includes one or more reward-issuance logic rules and prize data. For example, the reward-issuance logic rules correspond to certain prize-issuance rules. In another example, the virtual-reward-logic module includes one or more virtual reward-issuance logic rules and the real reward-logic module includes one or more real reward-issuance logic rules. In yet another example, the virtual-reward-logic module includes a virtual-article-logic module, a qualification-logic module, a third-party platform logic module, etc. In yet another example, if the determined reward-issuance logic rules are the virtual reward-issuance logic rules, the prize data corresponding to the virtual reward-issuance logic rules are updated and the corresponding virtual prize is issued to the user. In yet another example, if the determined reward-issuance logic rules are the real reward-issuance logic rules, the prize data corresponding to the real reward-issuance logic rules are updated and a reminder message is generated to remind the staff members to issue the corresponding real prize to the user.

According to yet another embodiment, when certain new reward-issuance logic rules conforms to a specification of the adaptation interface, the new reward-issuance logic rules and one or more corresponding prizes are added. For example, a new reward-logic module is added in the delivery layer, wherein the new reward-logic module includes the new reward-issuance logic rules and the corresponding prizes.

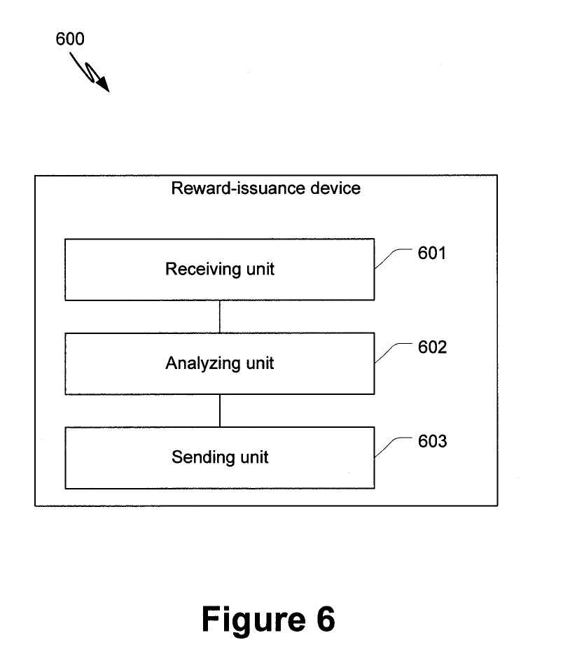

FIG. 6 is a simplified diagram showing a device for reward issuance according to one embodiment of the present invention. This diagram is merely an example, which should not unduly limit the scope of the claims. One of ordinary skill in the art would recognize many variations, alternatives, and modifications. The device 600 includes a receiving unit 601, an analyzing unit 602 and a sending unit 603. For example, the device 600 corresponds to a delivery-adaptation-layer entity.

According to one embodiment, the receiving unit 601 is configured to receive a reward-issuance request sent by a business-layer entity. For example, the business-layer entity generates a reward-issuance request according to a received user-task-fulfillment message and sends the generated reward-issuance request to the receiving unit 601. As an example, the analyzing unit 602 is configured to analyze the reward-issuance request and acquire a request identifier contained in the reward-issuance request. In another example, the request identifier is used to determine a reward-logic module contained in the delivery-layer entity. For example, the request identifiers correspond to various reward-logic modules in the delivery-layer entity. As an example, the delivery-layer entity includes a real reward-logic module, a virtual-article-logic module, a qualification-logic module, a third-party-platform-delivery-logic module, etc. These logic modules may be separately identified (e.g., as shown in FIG. 2), including a real reward-logic module 001, a virtual-article-logic module 002, a qualification-logic module 003, and a third-party-platform-delivery-logic module 004, in some embodiments. The logic modules may also be identified by other means. The request identifier of the reward-issuance request may be 001, 002, 003, and 004, in certain embodiments.

According to another embodiment, the sending unit 603 is configured to send the reward-issuance request to a corresponding reward-logic module in the delivery-layer entity according to the request identifier. For instance, if the request identifier extracted from the reward-issuance request is 002, the reward-issuance request is sent to the virtual-article-logic module 002 in the delivery-layer entity. For example, the sending unit 603 is configured to: send the reward-issuance request to one or more corresponding reward-logic modules in the delivery-layer entity via an adaptation interface according to the request identifier. As an example, the adaptation interface is configured to connect the delivery-adaptation-layer entity and the delivery-layer entity. In another example, the corresponding reward-logic modules in the delivery-layer entity receive the reward-issuance request sent by the delivery-adaptation-layer entity via the adaptation interface.

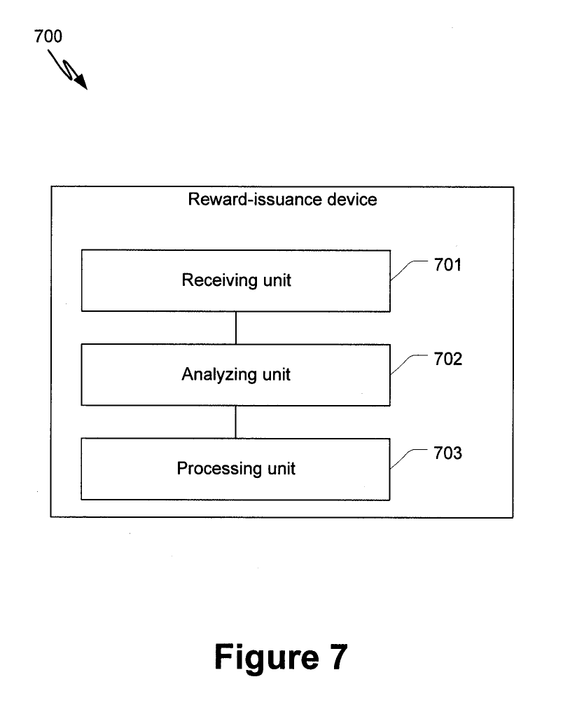

FIG. 7 is a simplified diagram showing a device for reward issuance according to another embodiment of the present invention. This diagram is merely an example, which should not unduly limit the scope of the claims. One of ordinary skill in the art would recognize many variations, alternatives, and modifications. The device 700 includes a receiving unit 701, an analyzing unit 702 and a processing unit 703. For example, the device 700 corresponds to a delivery-layer entity (e.g., a reward-logic module in the delivery-layer entity 103).

According to one embodiment, the receiving unit 701 is configured to receive a reward-issuance request sent by a business-layer entity via a delivery-adaptation-layer entity. For example, the delivery-adaptation layer where the delivery-adaptation-layer entity is located separates the business layer and the delivery layer so that the business layer and the delivery layer perform their respective functions independently so as to reduce the system coupling. In another example, the receiving unit 701 is configured to receive a reward-issuance request sent by the business-layer entity via the delivery-adaptation-layer entity through an adaption interface. In yet another example, the adaptation interface is configured to connect the delivery-adaptation-layer entity and the delivery-layer entity.

According to another embodiment, the analyzing unit 702 is configured to analyze the reward-issuance request and acquire a prize to be issued to a user contained in the reward-issuance request. For example, the processing unit 703 is configured to process issuance of the prize to the user according to the prize to be issued to the user. In another example, the processing unit 703 is configured to process issuance of the prize to the user according to the prize to be issued to the user and certain reward-issuance logic rules.

According to yet another embodiment, the reward-issuance logic rules correspond to one or more virtual reward-issuance logic rules or one or more real reward-issuance logic rules. For example, the reward-logic module contained in the delivery-layer entity includes certain reward-issuance logic rules and prize data. As an example, the reward-issuance logic rules correspond to certain prize-issuance rules. In another example, the virtual-reward-logic module includes one or more virtual reward-issuance logic rules and the real reward-logic module includes one or more real reward-issuance logic rules. In yet another example, the virtual-reward-logic module includes a virtual-article-logic module, a qualification-logic module, a third-party platform logic module, etc. In yet another example, if the determined reward-issuance logic rules are the virtual reward-issuance logic rules, the processing unit 703 is further configured to update the prize data corresponding to the virtual reward-issuance logic rules and issue the corresponding virtual prize to the user. In yet another example, if the determined reward-issuance logic rules are the real reward-issuance logic rules, the processing unit 703 is further configured to update the prize data corresponding to the real reward-issuance logic rules and generate a reminder message to remind the staff members to issue the corresponding real prize to the user.

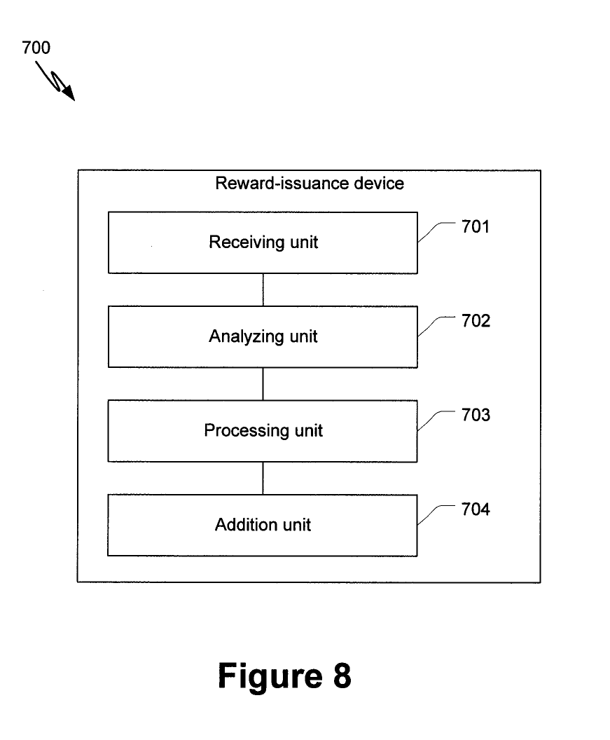

FIG. 8 is a simplified diagram showing the device 700 according to yet another embodiment of the present invention. This diagram is merely an example, which should not unduly limit the scope of the claims. One of ordinary skill in the art would recognize many variations, alternatives, and modifications. The device 700 further includes an addition unit 704.

According to one embodiment, the addition unit 704 is configured to add certain new reward-issuance logic rules and corresponding prizes if the new reward-issuance logic rules conform to a specification of the adaptation interface. For example, a new reward-logic module is added in the delivery layer, where the new reward-logic module includes the new reward-issuance logic rules and the corresponding prizes.

According to one embodiment, a system for reward issuance includes a business-layer entity, a delivery-adaptation-layer entity, and a reward-logic module in a delivery-layer entity. The business-layer entity is configured to receive a user-task-fulfillment message, generate, using one or more data processors, a reward-issuance request based on at least information associated with the user-task-fulfillment message, and output the reward-issuance request, the reward-issuance request including prize-related information. The delivery-adaptation-layer entity is configured to receive the reward-issuance request from the business-layer entity and output, using the one or more data processors, the reward-issuance request. The first reward-logic module in a delivery-layer entity is configured to receive the reward-issuance request from the delivery-adaptation-layer entity and process, using the one or more data processors, issuance of a first prize to a user based on at least the prize-related information of the reward-issuance request. The delivery-adaptation-layer entity is located between the business-layer entity and the delivery-layer entity. For example, the system is implemented according to at least FIG. 2, and/or FIG. 3.

According to another embodiment, a method is provided for reward issuance. For example, a reward-issuance request sent by a business-layer entity is received; the reward-issuance request is analyzed; a request identifier in the reward-issuance request; and the reward-issuance request is sent to a reward-logic module in a delivery-layer entity corresponding to the request identifier. For example, the method is implemented according to at least FIG. 4.

According to yet another embodiment, a method is provided for reward issuance. For example, a reward-issuance request sent by a business-layer entity via a delivery-adaptation-layer entity is received; the reward-issuance request is analyzed; prize-related information contained in the reward-issuance request is acquired; and issuance of a first prize to a user is processed based on at least the prize-related information. For example, the method is implemented according to at least FIG. 5.

According to yet another embodiment, a device for reward issuance includes a receiving unit, an analyzing unit, and a sending unit. The receiving unit is configured to receive a reward-issuance request sent by a business-layer entity. The analyzing unit is configured to analyze the reward-issuance request and acquire a request identifier in the reward-issuance request. The sending unit is configured to send the reward-issuance request to a reward-logic module in a delivery-layer entity corresponding to the request identifier. For example, the device is implemented according to at least FIG. 6.

In one embodiment, a device for reward issuance includes a receiving unit, an analyzing unit, and a processing unit. The receiving unit is configured to receive a reward-issuance request sent by a business-layer entity via a delivery-adaptation-layer entity. The analyzing unit is configured to analyze the reward-issuance request and acquire prize-related information contained in the reward-issuance request. The processing unit is configured to process issuance of a first prize to a user based on at least the prize-related information. For example, the device is implemented according to at least FIG. 7, and/or FIG. 8.

In another embodiment, a non-transitory computer readable storage medium includes programming instructions for reward issuance. The programming instructions are configured to cause one or more data processors to execute certain operations. For example, a reward-issuance request sent by a business-layer entity is received; the reward-issuance request is analyzed; a request identifier in the reward-issuance request; and the reward-issuance request is sent to a reward-logic module in a delivery-layer entity corresponding to the request identifier. For example, the storage medium is implemented according to at least FIG. 4.

In yet another embodiment, a non-transitory computer readable storage medium includes programming instructions for reward issuance. The programming instructions are configured to cause one or more data processors to execute certain operations. For example, a reward-issuance request sent by a business-layer entity via a delivery-adaptation-layer entity is received; the reward-issuance request is analyzed; prize-related information contained in the reward-issuance request is acquired; and issuance of a first prize to a user is processed based on at least the prize-related information. For example, the storage medium is implemented according to at least FIG. 4.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A processor-implemented system for reward issuance, comprising:
a business-layer entity configured to receive a user-task-fulfillment message, generate, using one or more data processors, a reward-issuance request based on at least information associated with the user-task-fulfillment message, and output the reward-issuance request, the reward-issuance request including prize-related information;
a delivery-adaptation-layer entity configured to receive the reward-issuance request from the business-layer entity and output, using the one or more data processors, the reward-issuance request; and
a first reward-logic module in a delivery-layer entity configured to receive the reward-issuance request from the delivery-adaptation-layer entity and process, using the one or more data processors, issuance of a first prize to a user based on at least the prize-related information of the reward-issuance request;
wherein the delivery-adaptation-layer entity is located between the business-layer entity and the delivery-layer entity.

2. The system of claim 1, wherein:
the delivery-layer entity includes one or more second reward-logic modules, the one or more second reward-logic modules including the first reward-logic module; and
a second reward-logic module includes reward-issuance-logic rules and prize data.

3. The system of claim 2, wherein:
the reward-issuance request includes a request identifier for determining one of the second reward-logic modules included in the delivery-layer entity;
the delivery-adaptation-layer entity is further configured to:
determine that the first reward-logic module in the delivery-layer entity corresponds to the request identifier based on at least information associated with the request identifier; and
send the reward-issuance request to the first reward-logic module.

4. The system of claim 2, wherein:
the one or more second reward-logic modules include one or more virtual-reward-logic modules and one or more real-reward-logic modules, the one or more virtual-reward-logic modules including one or more virtual-reward-issuance logic rules, the one or more real-reward-logic modules including one or more real-reward-issuance logic rules;
the first reward-logic module is further configured to:
in response to the first reward-logic module corresponding to a virtual-reward-logic module,
update first prize data contained in the first reward-logic module based on at least information associated with one or more first virtual-reward-issuance logic rules contained in the first reward-logic module; and
issue the first prize corresponding to a virtual prize to the user; and
in response to the first reward-logic module corresponding to a real reward-logic module,
update the first prize data based on at least information associated with one or more first real-reward-issuance logic rules contained in the first reward-logic module; and
generate a reminder message for reminding one or more staff members to issue the first prize corresponding to a real prize to the user.

5. The system of claim 1, further comprising:
an adaptation interface configured to connect the delivery-adaptation-layer entity and the delivery-layer entity.

6. The system of claim 5, wherein:
a third reward-logic module is added to the delivery-layer entity in response to one or more third reward-issuance logic rules contained in the third reward-logic module conforming to a specification of the adaptation interface.

7. A processor-implemented method for reward issuance, comprising:
receiving a reward-issuance request sent by a business-layer entity;
analyzing, using one or more data processors, the reward-issuance request;
acquiring, using the one or more data processors, a request identifier in the reward-issuance request; and
sending, using the one or more data processors, the reward-issuance request to a reward-logic module in a delivery-layer entity corresponding to the request identifier.

8. The method of claim 7, wherein:
the request identifier is used to determine the reward-logic module in the delivery-layer entity.

9. The method of claim 7, wherein the sending the reward-issuance request to a reward-logic module in a delivery-layer entity corresponding to the request identifier includes:
sending the reward-issuance request to the reward-logic module in the delivery-layer entity through an adaptation interface.

10. A processor-implemented method for reward issuance, comprising:
receiving a reward-issuance request sent by a business-layer entity via a delivery-adaptation-layer entity;
analyzing, using one or more data processors, the reward-issuance request;
acquiring, using the one or more data processors, prize-related information contained in the reward-issuance request; and
processing, using the one or more data processors, issuance of a first prize to a user based on at least the prize-related information.

11. The method of claim 10, wherein the receiving a reward-issuance request sent by a business-layer entity via a delivery-adaptation-layer entity includes:
receiving the reward-issuance request sent by the business-layer entity via the delivery-adaptation-layer entity through an adaption interface.

12. The method of claim 11, wherein the processing, using the one or more data processors, issuance of a first prize to a user based on at least the prize-related information includes:
processing issuance of the first prize to the user based on at least information associated with the first prize and one or more first reward-issuance logic rules.

13. The method of claim 12, wherein:
the one or more first reward-issuance logic rules correspond to one or more virtual-reward-issuance logic rules or one or more real-reward-issuance logic rules; and
the processing issuance of the first prize to the user based on at least information associated with the first prize and one or more first reward-issuance logic rules includes:
in response to the one or more first reward-issuance logic rules corresponding to one or more virtual-reward-issuance logic rules,
updating first prize data corresponding to the virtual-reward-issuance logic rules; and
issuing the first prize corresponding to a virtual prize to the user; and
in response to the one or more first reward-issuance logic rules corresponding to one or more real-reward-issuance logic rules,
updating second prize data corresponding to the real-reward-issuance logic rules; and
generating a reminder message for reminding one or more staff members to issue the first prize corresponding to a real prize to the user.

14. The method of claim 12, further comprising:
adding one or more second reward-issuance logic rules and a second prize corresponding to the second reward-issuance logic rules in response to the second reward-issuance logic rules conforming to a specification of the adaptation interface.

15. A device for reward issuance, comprising:
a receiving unit configured to receive a reward-issuance request sent by a business-layer entity;
an analyzing unit configured to analyze the reward-issuance request and acquire a request identifier in the reward-issuance request; and
a sending unit configured to send the reward-issuance request to a reward-logic module in a delivery-layer entity corresponding to the request identifier.

16. The device of claim 15, wherein the sending unit is further configured to send the reward-issuance request to the reward-logic module in the delivery-layer entity through an adaptation interface.

17. The device of claim 15, further comprising:
one or more data processors; and
a computer-readable storage medium;
wherein one or more of the receiving unit, the analyzing unit, and the sending unit are stored in the storage medium and configured to be executed by the one or more data processors.

18. A device for reward issuance, comprising:
a receiving unit configured to receive a reward-issuance request sent by a business-layer entity via a delivery-adaptation-layer entity;
an analyzing unit configured to analyze the reward-issuance request and acquire prize-related information contained in the reward-issuance request; and
a processing unit configured to process issuance of a first prize to a user based on at least the prize-related information.

19. The device of claim 18, wherein the receiving unit is further configured to receive the reward-issuance request sent by the business-layer entity via the delivery-adaptation-layer entity through an adaption interface.

20. The device of claim 19, wherein the processing unit is further configured to:
process issuance of the first prize to the user based on at least information associated with the first prize and one or more first reward-issuance logic rules, the one or more first reward-issuance logic rules corresponding to one or more virtual-reward-issuance logic rules or one or more real-reward-issuance logic rules;
in response to the one or more first reward-issuance logic rules corresponding to one or more virtual-reward-issuance logic rules,
update first prize data corresponding to the virtual-reward-issuance logic rules; and
issue the first prize corresponding to a virtual prize to the user; and
in response to the one or more first reward-issuance logic rules corresponding to one or more real-reward-issuance logic rules,
update second prize data corresponding to the real-reward-issuance logic rules; and
generate a reminder message for reminding one or more staff members to issue the first prize corresponding to a real prize to the user.

21. The device of claim 20, further comprising:
an addition unit configured to add one or more second reward-issuance logic rules and a second prize corresponding to the second reward-issuance logic rules in response to the second reward-issuance logic rules conforming to a specification of the adaptation interface.

22. The device of claim 18, further comprising:
one or more data processors; and
a computer-readable storage medium;
wherein one or more of the receiving unit, the analyzing unit, and the processing unit are stored in the storage medium and configured to be executed by the one or more data processors.

23. A non-transitory computer readable storage medium comprising programming instructions for reward issuance, the programming instructions configured to cause one or more data processors to execute operations comprising:
receiving a reward-issuance request sent by a business-layer entity;
analyzing the reward-issuance request;
acquiring a request identifier in the reward-issuance request; and
sending the reward-issuance request to a reward-logic module in a delivery-layer entity corresponding to the request identifier.

24. A non-transitory computer readable storage medium comprising programming instructions for reward issuance, the programming instructions configured to cause one or more data processors to execute operations comprising:
receiving a reward-issuance request sent by a business-layer entity via a delivery-adaptation-layer entity;
analyzing the reward-issuance request;
acquiring prize-related information contained in the reward-issuance request; and
processing issuance of a first prize to a user based on at least the prize-related information.
